(19) United States
(12) Patent Application Publication
(10) Pub. No.: US 2012/0245407 A1
(43) Pub. Date: Sep. 27, 2012

(54) Line Transmission for Vibratory Actuation in Implantable Transducers

(75) Inventor: Geoffrey R. Ball, Axams (AT)

(73) Assignee: VIBRANT MED-EL HEARING TECHNOLOGY GMBH, Innsbruck (AT)

(21) Appl. No.: 13/423,377

(22) Filed: Mar. 19, 2012

Related U.S. Application Data
(60) Provisional application No. 61/466,583, filed on Mar. 23, 2011.

(51) Int. Cl. H04R 25/00

(52) U.S. Cl. 600/25

(57) ABSTRACT

A transducer arrangement for a hearing implant is described. A bendable vibration transmission tube has a proximal end attached to a vibrational actuator, and a distal end with a drive surface for coupling vibration to an outer cochlea surface of a recipient patient. Multiple vibration coupling pieces have spherical outer surfaces and are arranged in a linear sequence within the transmission tube. A proximal-most coupling piece is in mechanical engagement with the vibrational actuator. A distal-most coupling piece is in mechanical engagement with the drive surface. The outer surfaces of adjacent coupling pieces are in mechanical engagement with each other. During surgical implantation to affix the vibrational actuator in the middle ear of the patient, the transmission tube accommodates bending so as to engage the drive surface against the cochlea surface, and vibration is coupled by the coupling pieces to the drive surface to vibrate the cochlea surface.

This application claims priority from U.S. Provisional Application 61/466,583, filed Mar. 23, 2001, which is incorporated herein by reference.

### TECHNICAL FIELD

The present invention relates to hearing implants and a vibration transmission arrangement for such.

### BACKGROUND ART

A normal ear transmits sounds as shown in FIG. 1 through the outer ear 101 to the tympanic membrane (eardrum) 102, which moves the ossicles of the middle ear 103 (malleus, incus, and stapes) that vibrate the oval window and round window openings of the cochlea 104. The cochlea 104 is a long narrow organ wound spirally about its axis for approximately two and a half turns. It includes an upper channel known as the scala vestibuli and a lower channel known as the scala tympani, which are connected by the cochlear duct. The cochlea 104 forms an upright spiraling cone with a center called the modiolar where the spiral ganglion cells of the acoustic nerve 113 reside. In response to received sounds transmitted by the middle ear 103, the fluid-filled cochlea 104 functions as a transducer to generate electric pulses which are transmitted to the cochlear nerve 113, and ultimately to the brain.

Hearing is impaired when there are problems in the ability to transduce external sounds into meaningful action potentials along the neural substrate of the cochlea 104. To improve impaired hearing, various types of hearing prostheses have been developed. For example, when a hearing impairment is related to the operation of the middle ear 103, a conventional hearing aid or a middle ear implant (MEI) device may be used to provide acoustic-mechanical vibration to the auditory system.

FIG. 1 also shows some components in a typical MEI arrangement where an external audio processor 111 processes ambient sounds to produce an implant communications signal that is transmitted through the skin to an implanted receiver 108. Receiver 108 includes a receiver coil that transcutaneously receives signals the implant communications signal which is then demodulated into a transducer stimulation signals which is sent over leads 109 through a surgically created channel in the temporal bone to a floating mass transducer (FMT) 110 in the middle ear. The transducer stimulation signals cause drive coils within the FMT 110 to generate varying magnetic fields which in turn vibrate a magnetic mass suspending within the FMT 110. The vibration of the inertial mass of the magnet within the FMT 110 creates vibration of the housing of the FMT 110 relative to the magnet. And since the FMT 110 is connected to the incus, it then vibrates in response to the vibration of the FMT 110 which is perceived by the user as sound.

### SUMMARY

Embodiments of the present invention are directed to a transducer arrangement for a hearing implant such as a middle ear implant system. A bendable vibration transmission tube has a proximal end attached to a vibrational actuator, and a distal end with a drive surface for coupling vibration to an outer cochlea surface of a recipient patient. Multiple vibration coupling pieces have spherical outer surfaces and are arranged in a linear sequence within the transmission tube. A proximal-most coupling piece is in mechanical engagement with the vibrational actuator. A distal-most coupling piece is in mechanical engagement with the drive surface. The outer surfaces of adjacent coupling pieces are in mechanical engagement with each other. During surgical implantation to affix the vibrational actuator in the middle ear of the patient, the transmission tube accommodates bending so as to engage the drive surface against the cochlea surface, and vibration of the vibration actuator is coupled by the coupling pieces to the drive surface to vibrate the cochlea surface.

In further specific embodiments, the cochlea surface may be the round window membrane or oval window membrane of the patient. The coupling pieces may be made of titanium, or they may be permanent magnets. Alternatively, a portion of coupling pieces may be permanent magnets and another portion may be of soft magnetic material. The transmission tube may hold the coupling pieces together under compressive force.

### BRIEF DESCRIPTION OF THE DRAWINGS

FIG. 1 shows the anatomy of a human ear and various structures in a middle ear hearing implant system.

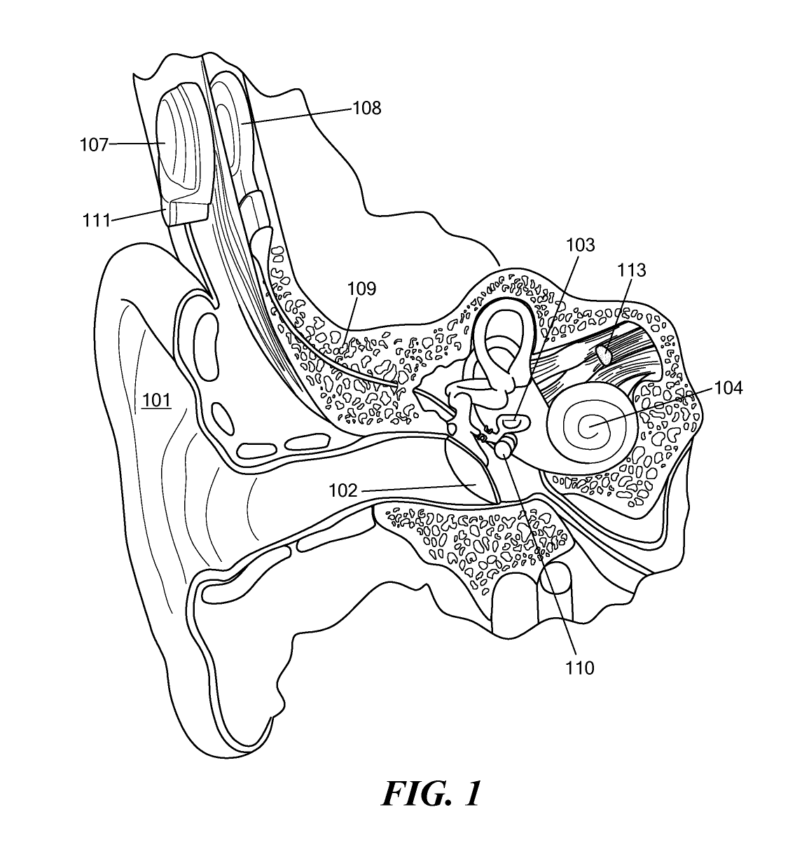

FIG. 2 A-C illustrates the vibration coupling principle of embodiments of the present invention.

FIG. 3 shows an example of one specific embodiment of the present invention.

### DETAILED DESCRIPTION

Various embodiments of the present invention are directed to a transducer arrangement for a hearing implant which encloses a sequence of transmission coupling pieces within a bendable outer tube. During surgical implantation to affix the vibrational actuator in the middle ear of the patient, the outer tube accommodates bending so as to engage a distal drive surface against the outer cochlea surface. And after implantation, vibration of the vibration actuator is coupled by the coupling pieces to the drive surface to vibrate the cochlea surface.

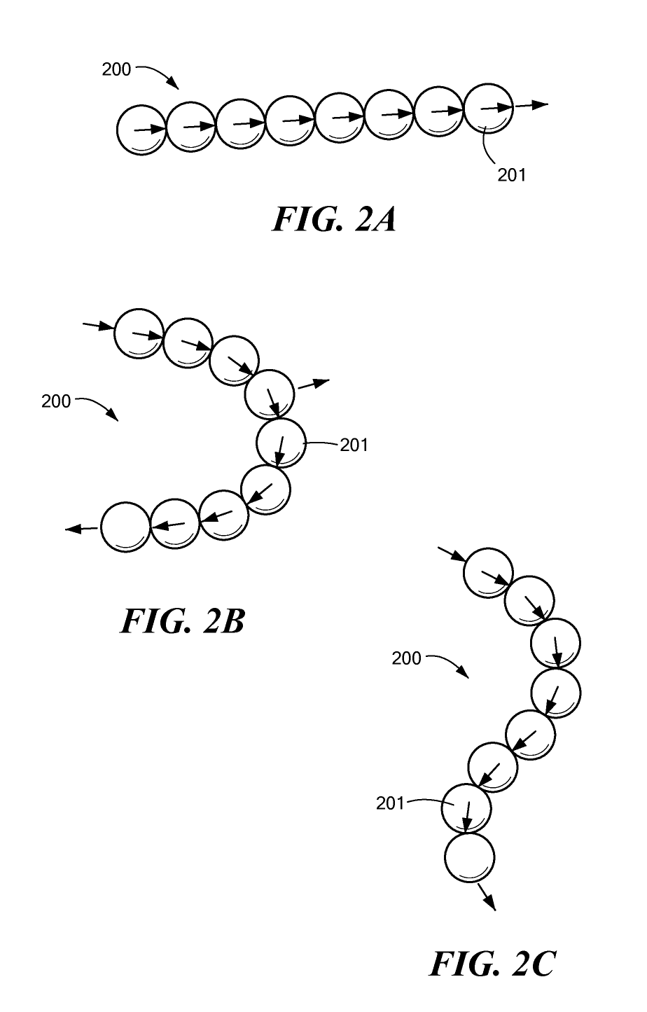

FIG. 2A shows a linear sequence 200 of vibration coupling pieces 201 arranged with their spherical outer surfaces in mechanical engagement with each other. A vibration applied to one end of the linear sequence 200 is transferred by each of the individual coupling pieces 201 to a corresponding vibration at the other end of the linear sequence 200, just as the swinging balls in a Newton's cradle transfer momentum and energy from the collision of a dropped ball at one end to make a ball at the other end jump. FIG. 2A illustrates this principle in simplest form with a sequence of ball shaped coupling pieces 201 arranged in a straight line linear sequence 200. But as FIG. 2B illustrates, the spherical outer surfaces of the coupling pieces 201 allow for bending of the linear sequence 200 into a curve shape which still transfers the vibrational energy from one end to the other. And as shown in FIG. 2C, the linear sequence 200 can be bent into more complex curves while still keeping the outer surfaces of the coupling pieces 201 in contact with each other so as to transfer vibrational movement from one end to the other.

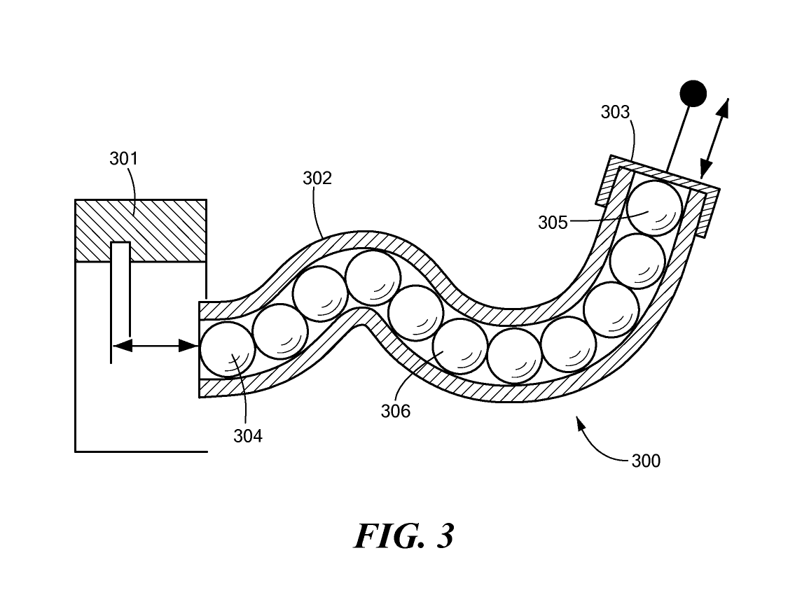

FIG. 3 shows an example of one specific embodiment of a transducer arrangement 300 for a hearing implant system that employs this principle. A bendable vibration transmission tube 302 has a proximal end attached to a vibrational actuator 301 and a distal end with a drive surface 303 for coupling vibration to an outer cochlea surface such as a round window or oval window membrane. Multiple vibration coupling pieces 306 have spherical outer surfaces and are arranged in a linear sequence within the transmission tube 302. In the embodiment in FIG. 3, the coupling pieces 306 are spherical titanium balls. In other embodiments, the coupling pieces 306 may be other forms or materials, for example, they may be permanent magnets. A proximal-most coupling piece 304 is in mechanical engagement with the vibrational actuator 301. A distal-most coupling piece 305 is in mechanical engagement with the drive surface 303. The transmission tube 302 holds the coupling pieces 306 together under compressive force so that the outer surfaces of adjacent coupling pieces 306 remain in mechanical engagement with each other as the transmission tube 302 is bent during insertion surgery.

Although various exemplary embodiments of the invention have been disclosed, it should be apparent to those skilled in the art that various changes and modifications can be made which will achieve some of the advantages of the invention without departing from the true scope of the invention.

What is claimed is:

1. A transducer arrangement for a hearing implant comprising:
a bendable vibration transmission tube having:
i. a proximal end attached to a vibrational actuator, and
ii. a distal end having a drive surface for coupling vibration to an outer cochlea surface of a recipient patient; and
a plurality of vibration coupling pieces having spherical outer surfaces and arranged in a linear sequence within the transmission tube with:
i. a proximal-most coupling piece in mechanical engagement with the vibrational actuator,
ii. a distal-most coupling piece in mechanical engagement with the drive surface, and
iii. the outer surfaces of adjacent coupling pieces in mechanical engagement with each other,
wherein during surgical implantation to affix the vibrational actuator in the middle ear of the patient, the transmission tube accommodates bending so as to engage the drive surface against the cochlea surface; and
wherein vibration of the vibration actuator is coupled by the coupling pieces to the drive surface to vibrate the cochlea surface.

2. A transducer arrangement according to claim 1, wherein the cochlea surface includes a round window membrane of the patient.

3. A transducer arrangement according to claim 1, wherein the cochlea surface includes an oval window membrane of the patient.

4. A transducer arrangement according to claim 1, wherein the coupling pieces are made of titanium.

5. A transducer arrangement according to claim 1, wherein the coupling pieces are permanent magnets.

6. A transducer arrangement according to claim 1, wherein the transmission tube holds the coupling pieces together under compressive force.

7. A middle ear implant system having a transducer arrangement according to any of claims 1 to 6.
